(19) United States
(12) Patent Application Publication
(10) Pub. No.: US 2025/0290746 A1
(43) Pub. Date: Sep. 18, 2025

(54) ALIGNMENT TOOL FOR GAS TURBINE SYSTEMS

(71) Applicant: Solar Turbines Incorporated, San Diego, CA (US)

(72) Inventor: Freddy Torres, San Diego, CA (US)

(73) Assignee: Solar Turbines Incorporated, San Diego, CA (US)

(21) Appl. No.: 18/603,267

(22) Filed: Mar. 13, 2024

(51) Int. Cl. G01B 11/27; F01D 25/28; F02C 7/36

(52) U.S. Cl. CPC G01B 11/272; F01D 25/285; F02C 7/36; F05D 2230/64; F05D 2260/30

(57) ABSTRACT

A system for aligning a rotating output shaft of a gas turbine with a rotating input shaft of a gearbox is disclosed. A turbine-side assembly has a first body configured to be attached to the casing of an engine and a rotatable alignment tool attached thereto. A gearbox-side assembly has a second body configured to be attached to the input power coupling of a gearbox and a rotatable second alignment tool attached thereto. The first alignment tool and second alignment tool are not physically coupled to one another, however, are configured to functionally communicate with each other to indicate when an output shaft and input shaft are aligned.

### TECHNICAL FIELD

The present disclosure relates generally to an alignment tool, and more particularly to an alignment tool for aligning gas turbines to generators and gearboxes.

### BACKGROUND

A gas turbine system typically includes a gas turbine engine coupled to a secondary device such as a gearbox or generator. This is commonly done via one or more shafts coupling an output end of the engine to an input end of the secondary device. The gas turbine system uses the engine to create rotational power which is transmitted to the secondary device through the shaft.

When setting up such a gas turbine system, the output end of the engine is usually aligned with the input end of the secondary device prior to the shaft(s) being installed between them. This alignment is generally conducted to ensure the shaft spins as straight as possible, such that vibration in the shaft is minimized while spinning at high speed during operation. Minimizing the vibration of the shaft prolongs the life of the setup and reduces power consumption.

A conventional way of aligning a gas turbine system is completed by initially doing a rough line-up between the engine and the secondary device. After the initial line-up is conducted, multiple measurements are taken of both the engine and secondary device. The collected measurements are then compared to a calculation sheet to determine how to move the engine with respect to the secondary device to achieve the desired alignment. Oftentimes after the engine has been moved the first time, the measurements of the engine and secondary device are then retaken and compared again to ensure accuracy, and further adjusted if necessary. However, such an approach is time consuming and presents opportunities for mistakes which may further delay the process or lead to suboptimal alignment.

U.S. Pat. No. 10,508,905B2 describes a device for measuring cavities. The device includes a holder, a main body, and two distance sensors. The holder is elongated in shape, has two ends opposite one another, the ends configured to affix the device to the inside of a cavity. The main body is rotatably coupled to the center of the holder such that the main body is held centrally within the cavity. The two distance sensors are mounted on different sides of the main body. One of the distance sensors is configured to measure inside of the cavity, while the other distance sensor is configured to measure in a direction parallel with the axis of rotation.

However, the device of the '905 patent is primarily directed to measuring distances such as the radius of a cavity, rather than assisting with alignment of two different objects. Further, the device of the '905 patent is designed such that it must be mounted centrally within a cavity, however, such a mounting configuration would not work for a turbine engine which has a shaft that already occupies that space. Additionally, the device of the '905 patent does not provide direct feedback with respect to the alignment of two objects, instead requiring additional equipment and user interpretation to be used for alignment purposes.

### SUMMARY

In an aspect of the present disclosure, a device is provided for aligning an output shaft of a gas turbine engine with an input shaft of a gearbox. The device includes a first body configured to be attached to the engine, the first body having a first mounting surface that defines a plane. The device also includes a hub assembly coupled to the first body and spaced from the first mounting surface such that the hub assembly does not intersect the plane. The hub assembly includes a rotating body that rotates around an axis perpendicular to the first mounting surface. The device also includes a locking mechanism that restricts the rotation of the rotating body. The device further includes a first alignment tool coupled to the rotating body such that the alignment tool rotates around the axis.

In another aspect of the present disclosure, a system is provided for aligning a rotating output shaft of a gas turbine with a rotating input shaft of a gearbox. The system includes a turbine-side assembly, which includes a first body having a first mounting surface configured to be coupled to a structure of the turbine other than the output shaft. A first alignment tool is coupled to the first body. The system further includes a gearbox-side assembly, which includes a second body having a second mounting surface configured to be coupled to the input shaft of the gearbox. A second alignment tool is coupled to the second body. The first alignment tool and second alignment tool are configured to functionally communicate with each other to indicate when the output shaft and input shaft are aligned.

In yet another aspect of the present disclosure, a method is provided for aligning an output shaft of an engine to an input shaft of a gearbox. The method includes attaching a first alignment device to the engine, the first alignment device including a first body. The method also includes attaching a second alignment device to the gearbox, the second alignment device including a second body that is not coupled to the first body. The method further includes attaching a first alignment tool to the first body such that the first alignment tool rotates around a first axis, and attaching a second alignment tool to the second body such that the second alignment tool rotates around a second axis. The method further includes rotating at least one of the first and second alignment tools to a position such that the first alignment tool and the second alignment tool are in functional communication. The method further includes adjusting the engine or gearbox until the output shaft and the input shaft are in a desired orientation.

Other features and aspects of this disclosure will be apparent from the following description and the accompanying drawings.

### BRIEF DESCRIPTION OF DRAWINGS

FIG. 1 is a perspective view of a gas turbine engine and a gearbox prior to alignment.

FIG. 2 shows a first alignment device, in partial section.

FIG. 3 shows a second alignment device, in partial section.

FIG. 4 is an exploded view showing the relationship between the first alignment device and the gas turbine engine.

FIG. 5 is an exploded view showing the relationship between the second alignment device and the gearbox.

FIG. 6 is a perspective view showing the gas turbine engine and the gearbox undergoing alignment using an alignment device.

FIG. 7 is a perspective view showing the gas turbine engine and gearbox aligned and with a shaft attached between them.

FIG. 8 is a flowchart illustrating a method of aligning a gas turbine system.

### DETAILED DESCRIPTION

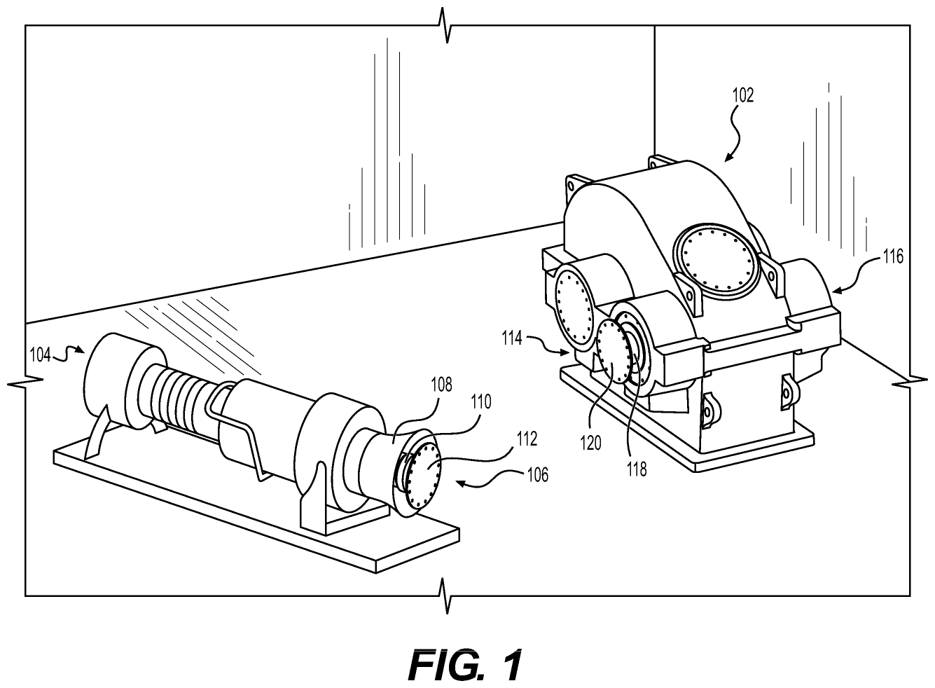

Referring to FIG. 1, there is shown a perspective view of a gas turbine engine 100 and a gearbox 102 prior to alignment. The gas turbine engine 100 uses a liquid or gaseous fuel such as diesel, kerosene, liquid petroleum gas, natural gas, hydrogen, or others. The fuel is combined with air pulled from the surrounding environment and combusted within the gas turbine engine 100 such that the stored energy within the fuel is released and converted into mechanical energy. The gearbox 102 is intended to be coupled to the gas turbine engine 100 and used to modify the mechanical output from the gas turbine engine 100 prior to transferring it to a device which uses the modified mechanical energy. Optionally, the gearbox 102 may be replaced by another device designed to be coupled to the gas turbine engine 100 and receive the mechanical output provided by the gas turbine engine 100, such as a generator which converts the mechanical energy to electrical energy.

The gas turbine engine 100 includes an upstream end 104, a downstream end 106, and a casing 108. The upstream end 104 includes an inlet which funnels air into the gas turbine engine 100. The downstream end 106 includes an output shaft 110 which is connected to a power output coupling 112. The casing 108 covers and protects the output shaft 110 and other internal components from damage, provides structure and mounting locations for the gas turbine engine 100, as well as maintains the high internal pressures and temperatures necessary for the gas turbine engine 100 to function properly.

In operation, the air enters through the inlet and is brought to a higher pressure through a compressor. The compressed air is then combined with a fuel to create a combustible mixture. This combination of the air and fuel is then combusted and the high-temperature, pressurized gas output is sent through a turbine which in turn spins the output shaft 110 and the power output coupling 112, thus providing a rotational mechanical.

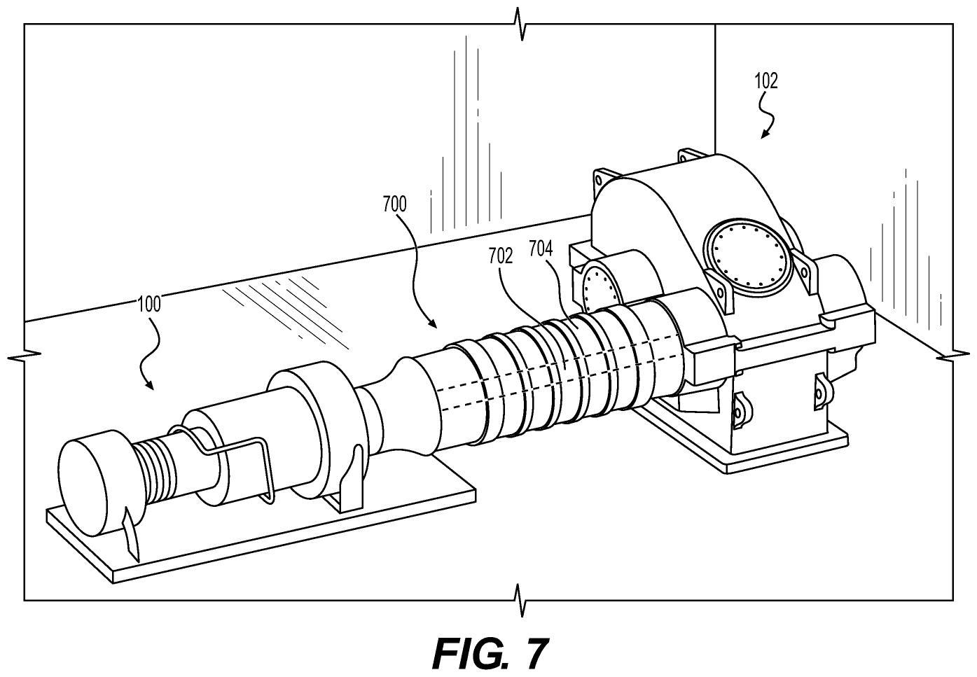

The gearbox 102 includes an input end 114 and an output end 116. The input end 114 includes an input shaft 118 coupled to a power input coupling 120. The power input coupling 120 of the gearbox 102 is configured to be coupled, though an intermediary central shaft 702 (discussed further below and shown in FIG. 7), to the power output coupling 112 of the gas turbine engine 100. Thereby, the gas turbine engine 100 is coupled to the gearbox 102 such that the gearbox 102 receives the rotational output of the gas turbine engine 100.

The gearbox 102 uses the input shaft 118 to receive the rotation of the output shaft 110 of the gas turbine engine 100 and outputs a different rotational speed through a shaft at the output end 116. Although not shown, the gearbox 102 may be coupled to a tertiary device which accepts the mechanical output of the gearbox 102. Optionally, the gearbox 102 may be replaced by a generator or other device which is able to receive the mechanical output of the gas turbine engine 100, such that the gearbox 102 is not necessary.

Due to the distance between the gas turbine engine 100 and the gearbox 102, controlling vibration in the central shaft 702 may significantly impact the efficiency and lifespan of the system. Accordingly, an alignment process may be almost necessary prior to installing the central shaft 702 between the gas turbine engine 100 and gearbox 102, such that the central shaft 702 spins as straight as possible to minimize any vibration. Initially, the gearbox 102 is affixed to the floor or other structure such that it is immovable. Once the gearbox 102 is affixed to the floor, the gas turbine engine 100 is placed roughly in position with respect to the gearbox 102.

Then, the gas turbine engine 100 and gearbox 102 undergo an alignment process, one approach being described herein. Once alignment is complete, the gas turbine engine 100 is affixed to the floor or other structure such that it is also immovable. Once the gas turbine engine 100 and the gearbox 102 are fixed in position, the central shaft 702 is installed between them, and the system is tested to ensure accuracy of the alignment prior to being put into service.

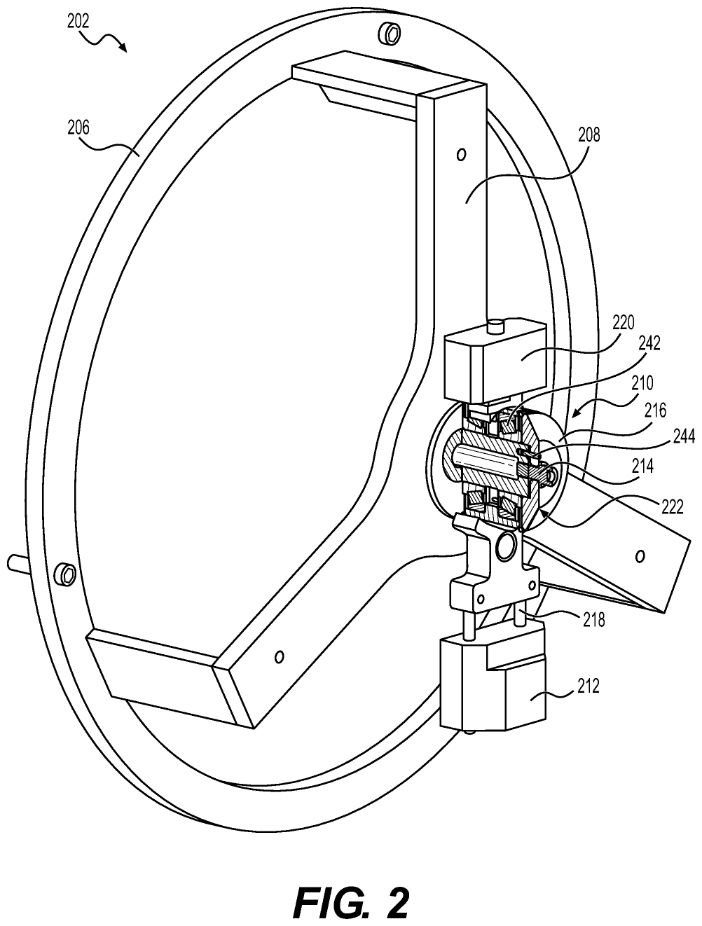

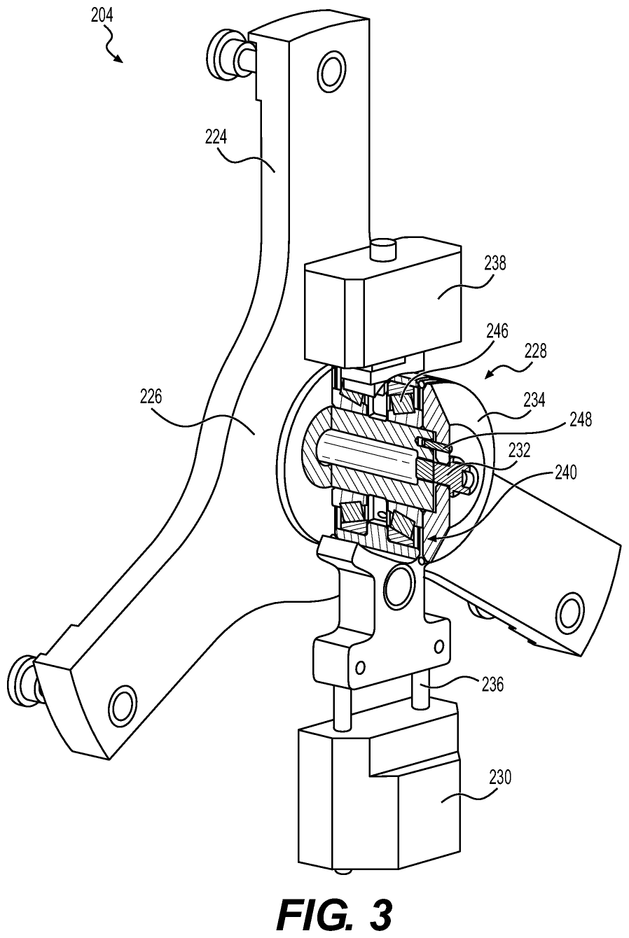

Referring to FIGS. 2 and 3, there are shown partial sectional views of a first alignment device 202 and second alignment device 204, which together form an alignment system 200. Both the first alignment device 202 and the second alignment device 204 are shown in a fully assembled configuration in these figures, such that they may be used after being coupled to their respective mounting locations.

Referring to FIG. 2, the first alignment device 202 includes an engine side mount 206, a first hub mount 208, a first hub 210, and a first alignment tool 212. The first hub 210 includes a first central mount 214, a first rotating body 216, a first alignment tool mount 218, a first counterweight 220, and a first locking mechanism 222.

The engine side mount 206 is coupled to the first hub mount 208 and provides the mounting location for the first alignment device 202. The engine side mount 206 is configured to be coupled to an engine or other device providing rotational power, such as the gas turbine engine 100. The engine side mount 206 is shown as a ring with a flat face, however in other embodiments may be any number of shapes and/or sizes such that it does not shift once it is coupled to the casing 108 of the gas turbine engine 100.

The first hub mount 208 is coupled to the engine side mount 206 as well as the first hub 210. The first hub mount 208 is configured to provide a secure central mounting location for the first hub 210, such that the first hub 210 is effectively coupled to the gas turbine engine 100. In the present embodiment, the first hub mount 208 is spaced away from the engine side mount 206 and has a plurality of arms to couple itself thereto. However, those skilled in the art will recognize that the first hub mount 208 may be any number of shapes and/or sizes, and in some embodiments, may be integrated with the engine side mount 206 such that the first hub 210 may be coupled directly to the engine side mount 206.

The first hub 210 is coupled to the first hub mount 208 and includes the features that allow sections of the first alignment device 202 to have rotational movement with respect to other sections. The first hub 210 is coupled to the first hub mount 208 through a first central mount 214. The first central mount 214 is fixedly coupled to the first hub mount 208 such that a portion of the first hub 210 does not rotate. In other embodiments, the first central mount 214 and/or the first hub 210 may be configured to rotate.

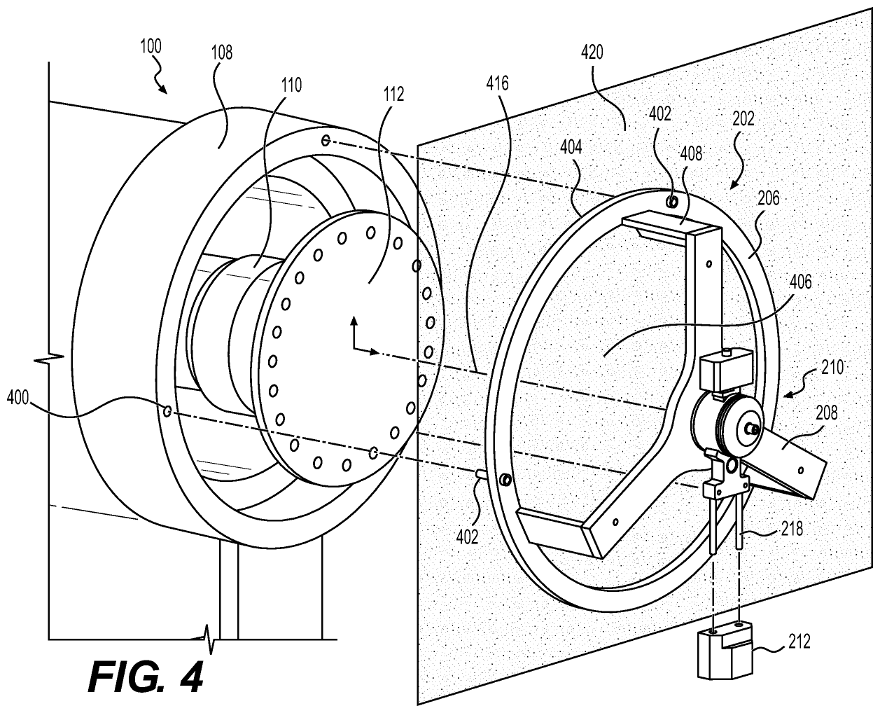

The first rotating body 216 is rotatably coupled to the first central mount 214. The first alignment tool mount 218 is coupled to the first rotating body 216, and the first alignment tool 212 is removably coupled to the first alignment tool mount 218. The first alignment tool 212 and the first rotating body 216 rotate around an output central axis 416 (discussed further below and shown in FIG. 4).

The first locking mechanism 222 is shown to be integrated within the housing of the first hub 210 and includes a ratcheting mechanism 242 and a set screw 244. The first locking mechanism 222 is configured to restrict the rotation of the first rotating body 216. The restriction of the first rotating body 216 may include limiting the direction of rotation of the first rotating body 216, slowing the rotation of the first rotating body 216, and/or completely preventing the first rotating body 216 from rotating.

The first counterweight 220 is coupled to the first rotating body 216 and sized such that the force it applies is substantially equal to the force the first alignment tool 212 applies. Accordingly, the unassisted rotational force exerted on the first rotating body 216 by the first alignment tool 214 and the first counterweight 220 at all positions is less than the force necessary to overcome the ratcheting mechanism 242 and/or the set screw 244 and rotate the first rotating body 216. Accordingly, the first rotating body 216 should not spin without being assisted by a user or other outside force.

Referring to FIG. 3, the second alignment device 204 includes a gearbox side mount 226, a second hub mount 226, a second hub 228, and a second alignment tool 230. Similarly to the structure of the first hub 210, the second hub 228 includes a second central mount 232, a second rotating body 234, a second alignment tool mount 236, a second counterweight 238, and a second locking mechanism 240.

The gearbox side mount 224 provides the mounting location for the second alignment device 204. The gearbox side mount 224 is configured to be coupled to a gearbox or other device which accepts rotational power, such as the illustrated gearbox 102. The gearbox side mount 224 is shown having a plurality of arms branching from a central location, however in other embodiments may be any number of shapes and/or sizes such that it does not shift or move once coupled to the gearbox 102.

The second hub mount 226 is shown integrated with the gearbox side mount 224. The second hub mount 226 is configured to provide a secure central mounting location for the second hub 228, such that the second hub 228 is effectively and securely coupled to the gearbox 102. However, those skilled in the art will recognize that the second hub mount 226 may be any number of shapes and/or sizes, and in some embodiments, may be distinctly separate from the gearbox side mount 224.

The second hub 228 is coupled to the second hub mount 226 and includes the features that allow sections of the second alignment device 204 to have rotational movement with respect to other sections. The second hub 228 is coupled to the second hub mount 226 through a second central mount 232. The second central mount 232 is fixedly coupled to the second hub mount 226 such that a portion of the second hub 228 does not rotate. In other embodiments, the second central mount 232 and/or the second hub 228 may be configured to rotate.

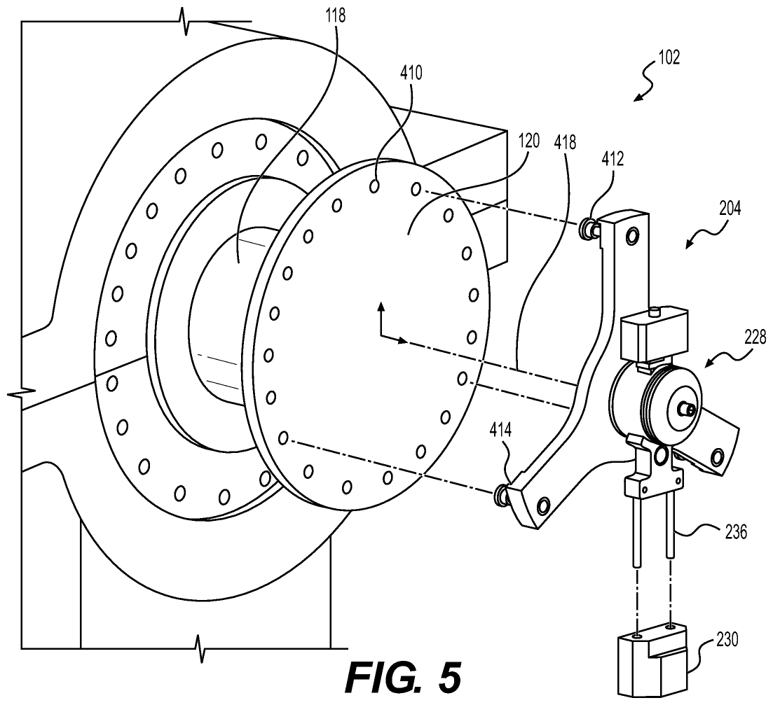

The second rotating body 234 is rotatably coupled to the second central mount 232. The second alignment tool mount 236 is coupled to the second rotating body 234, and the first alignment tool 212 is removably coupled to the first alignment tool mount 218. The second alignment tool 230 and the second rotating body 234 rotate around an input center axis 418 (discussed further below and shown in FIG. 5).

The second locking mechanism 240 is shown to be integrated within the housing of the second hub 228 and includes a ratcheting mechanism 246 and a set screw 248. The second locking mechanism 240 is configured to restrict the rotation of the second rotating body 234. The restriction of the second rotating body 234 may include limiting the direction of rotation of the second rotating body 234, slowing rotation of the second rotating body 234, and/or completely preventing the second rotating body 234 from rotating.

The first locking mechanism 222 and second locking mechanism 240 may include other structures to limit or prevent rotation of the first rotating body 216 and second rotating body 234. Such structures may include one or more threaded connections, pins, magnets, and the like and combinations thereof. Optionally, first locking mechanism 222 and/or second locking mechanism 240 may contain no movement-restricting structures, such that there are no restrictions on rotation.

As with the first counterweight 220, the second counterweight 238 is sized such that the force it applies is substantially equal to the force second alignment tool 230 applies. Accordingly, the unassisted rotational force exerted on the second rotating body 234 may be equal to or less than the force necessary to overcome the ratcheting mechanism 246 and/or set screw 248 and rotate the second rotating body 234.

The first alignment tool 212 and second alignment tool 230 are a laser and a sensor, such that one sends a signal and the other receives the signal. Accordingly, all communication between the first alignment device 202 and the second alignment device 204 happens electronically through the first alignment tool 212 and the second alignment tool 230. However, in other embodiments, the first alignment tool 212 and/or second alignment tool 230 may each include a laser and sensor such that they both send and receive signals.

Accordingly, the alignment system 200 shown in FIG. 2 and FIG. 3 does not include any physical connections between the first alignment device 202 and the second alignment device 204. However, in other embodiments, the alignment system 200 may have one or more physical connections between the first alignment device 202 and second alignment device 204 such that the alignment system 200 need not rely solely on wireless communication. In further embodiments, there may be no electronic communication between the first alignment device 202 and second alignment device 204.

Further, in some embodiments, the alignment system 200 may consist of a single side containing a first and/or second body which may be either the turbine-side assembly (first alignment device 202) or the gearbox side assembly (second alignment device 204). Such a device may mount only on the engine side or the gearbox side, or it may be configured such that it may mount on both.

Referring to FIG. 4, there is shown an exploded view of the first alignment device 202 and the gas turbine engine 100. The first alignment device 202 is shown in position to be mounted to the casing 108 of the gas turbine engine 100, with the first alignment tool 212 in position to be mounted to the first alignment tool mount 218.

To complete mounting of the first alignment device 202 to the gas turbine engine 100, the engine side mount 206 is coupled to the casing 108 through one or more fasteners 402 which pass through the engine side mount 206 and into a casing mount 400. Engine side mount 206 includes a mounting surface 404 which is configured to mate with the casing 108. The fasteners 402 are shown as bolts which pass through a plurality of holes in the engine side mount 206 and into the casing mount 400. However, in other embodiments the fasteners 402 may be any number of mechanical fasteners, including but not limited to pins, screws, clamps, clips, clasps, and the like and combinations thereof.

The mounting surface 404 defines a plane 420 and is configured to be coupled to the casing 108 such that the plane 420 exists where they mate. The plane 420 is also perpendicular to the output central axis 416 which defines the intended rotational axis of the output shaft 110. The first hub 210 is configured to be in line with the output central axis 416 of the output shaft 110. The first alignment tool mount 218 is configured to rotate around the output central axis 416. The first alignment tool mount 218 is removably couplable to the first alignment tool 212, such that when the first alignment tool 212 is placed on the first alignment tool mount 218, the first alignment tool 212 rotates around the output central axis 416.

In some embodiments, the output shaft 110 and/or power output coupling 112 extend past the casing 108. Consequently, and as shown, the first alignment device 202 may be recessed or hollow in a central area such that the first alignment device 202 does not contact the output shaft 110 or power output coupling 112. A ring-shaped embodiment of the engine side mount 206 is shown, with a central void 406 and a plurality of spacers 408 attached between the engine side mount 206 and first hub mount 208, thereby pushing back the first hub mount 208 further away from the casing 108. The power output coupling 112 fits within the void 406 and does not contact the first hub mount 208. This allows the engine side mount 206 to be properly attached to the casing 108 without the power output coupling 112 interfering with the first alignment device 202. In such an embodiment, the first hub 210 does not intersect the plane 420.

Referring to FIG. 5 there is shown an exploded view of the second alignment device 204 and the gearbox 102. The second alignment device 204 is shown in position to be mounted to the power input coupling 120 of the gearbox 102, with the second alignment tool 230 in position to be mounted to the second alignment tool mount 236.

To complete mounting of the second alignment device 204 to the gearbox 102, the second alignment device 204 is coupled to the power input coupling 120 through one or more fasteners 412 which pass through the second alignment device 204 and through an aperture 410 in the power input coupling 120. In some embodiments, the fasteners 412 may thread into a tapped hole in the power input coupling 120 and/or second alignment device 204. The fasteners 412 are shown as bolts, however in other embodiments they may be any number of mechanical fasteners, including but not limited to pins, screws, clamps, clips, clasps, and the like and combinations thereof.

The second alignment device 204 contacts the face of the power input coupling 120 of the gearbox 102 and includes a lip 414 which extends past the face of the power input coupling 120 and contacts or comes very close to the side(s) thereof and assists with centering the second hub 228. In other embodiments, the lip 414 may be removed such that the second alignment device 204 may be used on a range of power input couplings 120.

The second hub 228 is shown in line with the input central axis 418 of the input shaft 118. The second alignment tool mount 236 is coupled to the second alignment device 204 such that it rotates around the input central axis 418. The second alignment tool mount 236 is removably coupled to the second alignment tool 230, such that when the second alignment tool 230 is placed on the second alignment tool mount 236, the second alignment tool 230 rotates around the input central axis 418.

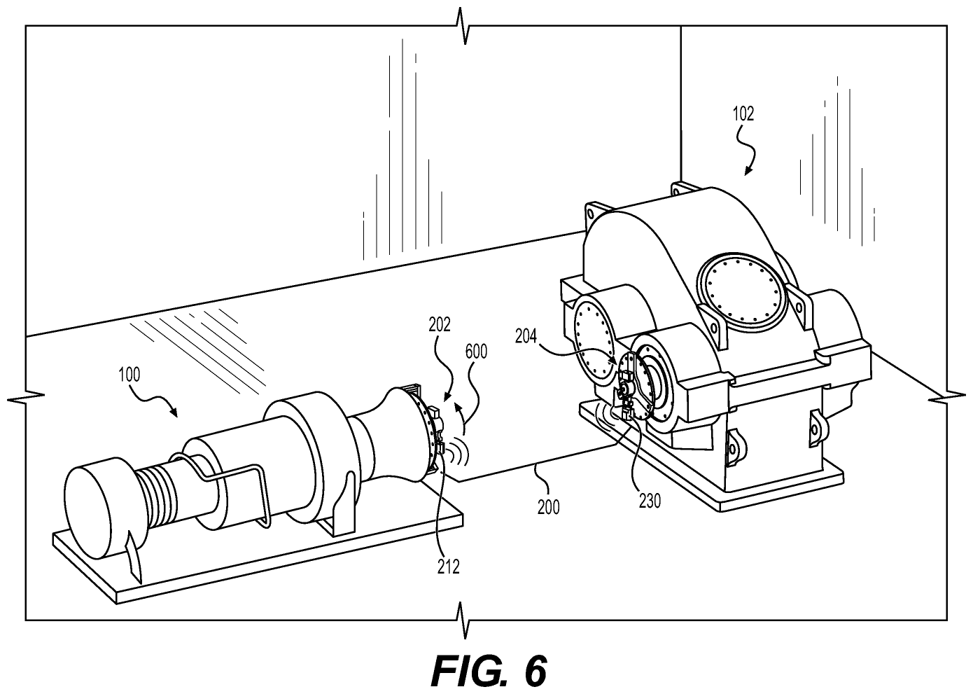

Accordingly, the alignment system 200 (shown fully in FIG. 6), when installed, locates both the output central axis 416 of rotation of the output shaft 110 of the gas turbine engine 100 and the input central axis 418 of rotation of the input shaft 118 of the gearbox 102. Then, the alignment system 200 is used to align the two axes 416, 418 such that they become essentially coextensive. If the two axes 416, 418 are appropriately aligned when the input shaft 110 and output shaft 118 are coupled by the central shaft 702 and spinning at operational speed, vibration of the central shaft 702 should be appropriately managed.

Referring to FIG. 6, a perspective view of the gas turbine engine 100 and the gearbox 102 undergoing alignment using the alignment system 200 is illustrated. The gas turbine engine 100 is shown roughly in alignment with the gearbox 102. The first alignment device 202 is shown attached to the gas turbine engine 100 and the second alignment device 204 is shown attached to the gearbox 102. Accordingly, the alignment system 200 is shown to be in an assembled and operational state.

As shown, the first alignment device 202 is in communication with the second alignment device 204 such that they may send and/or receive data from each other. As illustrated, that communication is wireless electrical communication between the alignment tools 212, 230 of each respective device 202, 204.

Once the first alignment device 202 and second alignment device 204 have established functional communication in a first position, the two tools 212, 230 are then rotated, indicated at 600, in the same direction (e.g. one clockwise and one counterclockwise) such that they mirror each other around generally the same axis (the input central axis 416 and output central axis 418 should be generally aligned) such that they remain in functional communication during the entirety of rotation. The alignment tools 202, 230 are rotated at least once completely around such that they may communicate information at all necessary positions. If the devices 202, 204 lose communication prior to completing one rotation, the position of the gas turbine engine 100 and/or the gearbox 102 should be further adjusted such that communication between the first alignment device 202 and second alignment device 204 is maintained throughout the rotation.

Once the rotation is complete, the alignment system 200 returns a result which may indicate that the gas turbine engine 100 and gearbox 102 are sufficiently aligned. If not, the alignment system 200 may return a result which may be used to relocate the gas turbine engine 100 or gearbox 102 to a better position, in which case an additional alignment process may take place to properly align the system. Such a result may include an auditory, visual, and/or tactile indicator.

Once the alignment system 200 has indicated that the gas turbine engine 100 and the gearbox 102 are aligned, the two may be coupled together such that rotational power from the gas turbine engine 100 is provided to the gearbox 102. This is done by removing the first alignment device 202 and second alignment device 204 and then installing a central shaft 702 to the power output coupling 112 and power input coupling 120.

If the positioning between the gas turbine engine 100 and gearbox 102 was not close enough, the devices 202, 204 of the alignment system 200 may not be able to achieve functional communication and the alignment system 200 may not be able to assist with the final alignment of the gas turbine engine 100 and the gearbox 102. Further manual or assisted alignment may be necessary prior to the alignment system 200 being used.

Although not shown, in some embodiments, the alignment system may include additional devices which are used to process information and/or display information to a user. Examples of such devices may include, but are not limited to a computer, smartphone, tablet, processor, monitor, screen, various indicators (audible noise, lights, vibration, etc.), and the like and combinations thereof. Such additional device(s) may be beneficial to the system and/or a user, for example by giving the user an indication of various aspects of the process, some examples including: how to operate the alignment system 200, how to shift the gas turbine engine 100 and/or gearbox 102, when alignment is completed, any issues with alignment, or errors encountered by the alignment system 200.

Although shown as a two-piece wireless device, in other embodiments the first alignment device 202 and second alignment device 204 may communicate in other ways, such as wired communication. In further embodiments, they may not communicate with one another, rather relying on the user or peripheral device(s) to interpret their output(s).

Referring to FIG. 7, a perspective view of the gas turbine engine 100 and gearbox 102 aligned and with a central shaft assembly 700 attached is illustrated. The central shaft assembly 700 includes a central shaft 702 as well as a shaft casing 704, the shaft casing 704 concealing the central shaft 702, as shown. Although concealed by the shaft casing 704, the central shaft is coupled to the power output coupling 112 and power input coupling 120 and transfers the rotational power generated by the gas turbine engine 100 to the gearbox 102. The shaft casing 704 couples to the engine casing 108 and to the gearbox 102 and covers and protects the central shaft 702 during operation. The shaft casing 704 is fixed to the engine 100 and gearbox 102 such that it does not rotate.

If aligned properly, the output central axis 416, the input central axis 418, and center of the central shaft 702 will be generally aligned along a single longitudinal axis that passes through the assembly. If achieved, there should be minimal vibration when the system is operational and the components are being rotated at speed.

### INDUSTRIAL APPLICABILITY

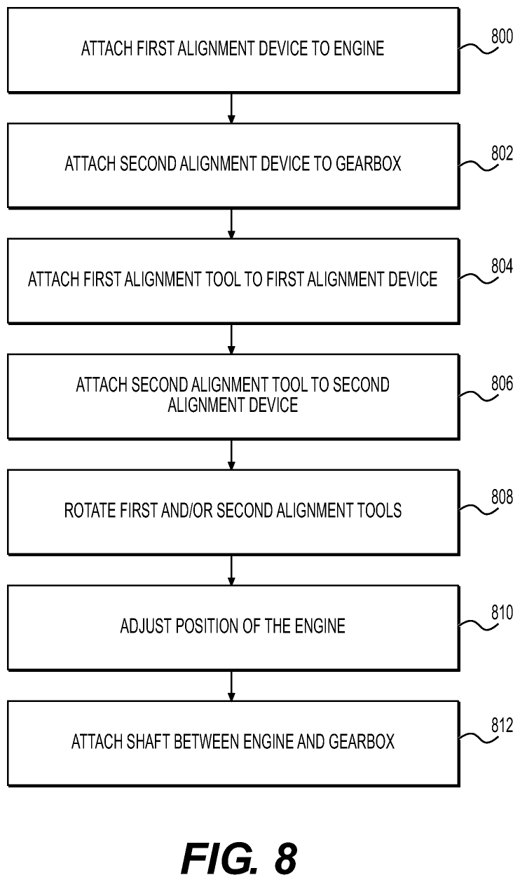

Referring to FIG. 8, a flowchart of a method of aligning a gas turbine system is illustrated. To capture the mechanical output of the gas turbine engine 100, the output shaft 110 of the gas turbine engine 100 needs to be coupled to a secondary device, such as the gearbox 102.

Generally, the gearbox 102 is first positioned in a suitable area and fastened such that it is fixed in position. Once it is in position, the gas turbine engine 100 is set roughly at an appropriate distance from the gearbox 102 positioned such that the gas turbine engine 100 and gearbox 102 are close to being in a desired final position, only needing some minor adjustments to align them prior to connecting the central shaft 702.

Afterwards, the alignment process using the alignment device 200 begins. At step 800, the first alignment device 202 is attached to the gas turbine engine 100. At this step, the first alignment device 202 is fastened to the casing 108 of the gas turbine engine 100 with fasteners 402 securing the first alignment device 202 to the casing mount 400. At step 802, the second alignment device 204 is attached to the gearbox 102. At this step, the second alignment device 204 is fastened to the input shaft 118 of the gearbox 102 with fasteners 412.

At step 804, the first alignment tool 212 is attached to the first alignment device 202, and at step 806, the second alignment tool 230 is attached to the second alignment device 204. In these steps 804, 806, the respective alignment tools 212, 230 are slid onto the respective alignment tool mounts 218, 232.

At step 808, the first alignment tool 212 and/or the second alignment tool 230 are rotated such that they end up in functional communication with one another. Functional communication refers to the first alignment tool 212 and/or second alignment tool 230 sending a signal to the other device, and the other device receiving that signal. Once functional communication is established between the first alignment tool 212 and the second alignment tool 230, they are rotated simultaneously around their corresponding axes such that they remain in functional communication with one another.

Once the first full rotation is completed, the results from the tools 212, 230 are analyzed and displayed, generally resulting in the need to adjust the position of the gas turbine engine 100. At step 810, the gas turbine engine 100 may be slightly adjusted into a new position. Steps 808 and 810 may be repeated until the gas turbine engine 100 is in a satisfactory position with respect to the gearbox 102.

Once the gas turbine engine 100 is in the desired position, it is fastened to the floor or other structure such that it is fixed in position. Then, the alignment system 200 is removed from the gas turbine engine 100 and gearbox 102, such that the power input coupling 120 and power output coupling 112 are exposed. At step 812, the central shaft 702 is placed between the gas turbine engine 100 and the gearbox 102 and coupled to both the power input coupling 120 and power output coupling 112.

Following the above process, the gas turbine engine 100 and gearbox 102 should be aligned with one another and connected such that any vibration from the central shaft 702 is managed. This may improve the efficiency and service life of the gas turbine engine 100, central shaft 702, and gearbox 102.

The steps of coupling the alignment device(s) to the engine and/or gearbox as well as the steps of attaching the tool(s) to their respective alignment devices are illustrated above in one order, however these steps may occur in any order without interfering with the functionality of the alignment system 200. The tools 212, 230 may also be attached to the alignment devices 202, 204 prior to or simultaneously with the alignment devices 202, 204 being attached to the gas turbine engine 100 and gearbox 102.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of the disclosure. Such embodiments should be understood to fall within the scope of the present disclosure as determined based upon the claims and any equivalents thereof.

What is claimed is:

1. A device for aligning an output shaft of a gas turbine engine with an input shaft of a gearbox, comprising:
a first body configured to be attached to the engine, the first body having a mounting surface that defines a plane;
a hub assembly coupled to the first body and spaced from the mounting surface such that the hub does not intersect the plane, the hub assembly including:
a rotating body that rotates around an axis perpendicular to the first mounting surface; and
a locking mechanism that restricts the rotation of the rotating body; and
a first alignment tool coupled to the rotating body such that the first alignment tool rotates around the axis.

2. The device of claim 1, the hub assembly further including a weighted section coupled to the rotating body opposite the first alignment tool.

3. The device of claim 1, wherein the locking mechanism is a ratchet or set screw.

4. The device of claim 1, wherein the first alignment tool is removably coupled to the rotating body.

5. The device of claim 1, wherein the mounting surface is configured to attach to a casing of the turbine engine that surrounds the output shaft.

6. The device of claim 1, further comprising a second body configured to be attached to the input shaft of the gearbox, the second body not coupled to the first body.

7. The device of claim 6, further comprising a second alignment tool coupled to the second body, the first alignment tool and the second alignment tool being configured to functionally communicate with each other.

8. The device of claim 7, wherein the first alignment tool and second alignment tool collectively include a laser and a sensor.

9. A system for aligning a rotating output shaft of a gas turbine with a rotating input shaft of a gearbox, comprising:
a turbine-side assembly, including:
a first body having a first mounting surface configured to be coupled to a structure of the turbine other than the output shaft; and
a first alignment tool coupled to the first body; and
a gearbox-side assembly, including:
a second body having a second mounting surface configured to be coupled to the input shaft of the gearbox; and
a second alignment tool coupled to the second body;
wherein the first alignment tool and second alignment tool are configured to functionally communicate with each other to indicate when the output shaft and input shaft are aligned.

10. The system of claim 9, wherein the first mounting surface is configured to be coupled to a casing of the turbine that surrounds the output shaft.

11. The system of claim 9, wherein the first alignment tool is rotatably coupled to the first body such that
the first alignment tool rotates around a central axis of the first body; and
the second alignment tool is rotatably coupled to the second body such that the second alignment tool rotates around a central axis of the second body.

12. The system of claim 9, wherein the first alignment tool and the second alignment tool collectively include a laser and a sensor.

13. The system of claim 9, further comprising:
a first locking mechanism that restricts rotation of the first alignment tool; and
a second locking mechanism that restricts rotation of the second alignment tool.

14. The system of claim 13, further comprising:
a first counterweight rotatably coupled to the first body opposite the first alignment tool; and
a second counterweight rotatably coupled to the second body opposite the second alignment tool.

15. The system of claim 9, wherein the input shaft includes an input coupling, the second mounting surface attached to a face of the input coupling.

16. A method of aligning an output shaft of an engine to an input shaft of a gearbox, comprising:
attaching a first alignment device to the engine, the first alignment device including a first body;
attaching a second alignment device to the gearbox, the second alignment device including a second body that is not coupled to the first body;
attaching a first alignment tool to the first body such that the first alignment tool rotates around a first axis;
attaching a second alignment tool to the second body such that the second alignment tool rotates around a second axis;
rotating at least one of the first and second alignment tools to a position such that the first alignment tool and the second alignment tool are in functional communication; and
adjusting the engine or gearbox until the output shaft and the input shaft are in a desired orientation.

17. The method of claim 16, wherein attaching a first alignment device includes attaching the first body to a casing of the engine.

18. The method of claim 16, wherein the first and second alignment devices collectively include a laser and a sensor.

19. The method of claim 16, wherein the position is a first position, and further including rotating the first alignment tool and the second alignment tool to a second position such that the first alignment tool and the second alignment tool are in functional communication.

20. The method of claim 19, further including adjusting the engine or gearbox such that the first and second alignment tools are aligned.
